(19) United States
(12) Patent Application Publication
(10) Pub. No.: US 2016/0292842 A1
(43) Pub. Date: Oct. 6, 2016

(54) Method and Apparatus for Enhanced Digital Imaging

(71) Applicant: Nokia Technologies Oy, Espoo (FI)

(72) Inventors: Tom PYLKKANEN, Kaarina (FI); Sumeet SEN, Tampere (FI); Janne KORHONEN, Tampere (FI)

(73) Assignee: Nokia Technologies Oy, Espoo (FI)

(21) Appl. No.: 15/034,894

(22) PCT Filed: Nov. 18, 2013
(86) PCT No.: PCT/FI2013/051078

§ 371 Date: May 6, 2016

(51) Int. Cl. G06T 7/00; H04N 5/232; H04N 13/02; H04N 5/225

(52) U.S. Cl. CPC G06T 7/002; G06T 7/0081; G06T 7/0075; H04N 5/2259; H04N 5/23248; H04N 13/0239; G06T 2207/20144; G06T 2207/20212; G06T 2207/20228

(57) ABSTRACT

Method, apparatus and computer programs are disclosed for forming synthesized panning of images. Based on a pair of digital images taken by a pair of digital cameras and their calibration information, a disparity map is formed for image objects in the pair of digital images. A combined image is formed using the pair of digital images. The combined image is segmented, using the disparity map, to include a foreground region and a background region. A sequence of synthesized panning images is formed so that for each combined image; a perspective shift is applied between the foreground region and background region; and a shifting portion of the perspective shifted image is cropped.

### TECHNICAL FIELD

The present application generally relates to enhanced digital imaging.

### BACKGROUND

This section illustrates useful background information without admission of any technique described herein representative of the state of the art.

Digital cameras have become ubiquitous thanks to camera enabled mobile phones. There are also various other portable devices that are camera enabled, but mobile phones are practically always carried along by their users. Resulting proliferation of digital images has enabled taking numerous images that please their respective photographers. The need for enhancing the image viewing experience has been accented by the sheer amount of images people see.

Various technical solutions have been developed to enhance the experience of taking digital images. Optical and digital image stabilization have enabled longer exposure times which let photographers use more freely their digital cameras. 3D imaging makes use of a pair of cameras and special displays and/or 3D glasses worn by the viewers. Different tone effects and distortions have been developed to touch up images so as to make them more pleasing. There are even images that combine motion to still images, also known as cinemagraphs. Cinemagraphs yet require suitable motion such as some grass moving in the wind or water running from a tap. Image viewing has also been enhanced in various slide shows by applying suitable slide in and slide out effects. There is still need for further enhancing the digital camera use experience.

### SUMMARY

Various aspects of examples of the invention are set out in the claims.

According to a first example aspect of the present invention, there is provided an apparatus comprising:
at least one memory configured to store calibration information;
two digital image capture units configured to take a respective pair of digital images at given offset from one another, with overlapping fields of view so that some image objects may appear in each of the pair of digital images;
the at least one memory being further configured to store the pair of digital images;
a processor configured to:
produce, based the calibration information and the pair of digital images, a disparity map for the pair of digital images;
form a combined image using the pair of digital images;
segment the combined image, using the disparity map, to comprise a foreground region and a background region;
form a sequence of synthesized panning images so that for each combined image:
   a perspective shift is applied between the foreground region and background region; and
   a shifting portion of the perspective shifted image is cropped.

The disparity map may be formed for the image objects in the pair of the digital images.

The segmenting of the combined image may be performed by segmenting the combined image into the foreground region and the background region.

The perspective shifting may be applied by shifting at least one of the foreground region and background region.

The two digital image capture units may be formed of two digital cameras. Alternatively, the two digital image capture units may be formed of a common digital camera and of an optical image splitter with two offset and substantially parallel image input ports. The optical image splitter may comprise one or more components selected from a group consisting of mirrors; prisms; afocal optical elements; exit pupil expanders; and focal optical elements.

The pair of digital images may have substantially overlapping fields of view. The optical axis may be parallel or nearly parallel (e.g. up to 1, 2, 3, 4 or 5 degrees difference) when the pair of digital images are taken.

The forming of a combined image from the pair of digital images may be performed by mosaicking.

The segmenting of the scene may be performed with depth based segmentation algorithm(s). The user may be allowed to identify the foreground region to facilitate the segmentation.

The processor may be further configured to form an animation file of the sequence of the synthesized panning images.

The apparatus may further comprise an optical image stabilization unit configured to optically stabilize at least one of the digital images of the pair of digital images.

The processor may be configured to control the optical image stabilization unit and to control the image capture units so as to take multiple images shifting the view affected by optical image stabilization unit from one image to another in the direction of the synthesized panning.

The apparatus may further comprise a display. The processor may be further configured to present a preview on the display to illustrate synthesized panning that can be produced with current view of the image capture units.

The apparatus may further comprise a user input. The processor may be further configured to enable user determination of at least one parameter and to use the at least one parameter in any one or more of the producing of the disparity map; forming of the combined image; segmenting of the combined image; and forming of the sequence of synthesized panning images.

The user input may comprise a touch screen. The processor may be configured to at least partly form the at least one parameter by recognizing a gesture such as swiping on the touch screen.

The processor may be configured to control the optical image stabilization unit to perform both image stabilization and the shifting of the view. The optical image stabilization may be performed to the extent possible after the shifting of the view.

The processor may be configured to cause the digital image capture units to take a plurality of the pairs of the digital images and causing the optical image stabilization unit to perform the shifting of the view differently for different pairs of digital images. The processor may be configured to perform the producing of the disparity map based on the plurality of pairs of digital images. The processor may be configured to perform the forming of the combined image using the plurality of pairs of digital images.

The processor may be further configured to use the changing mutual geometry of the image capture units to facilitate the producing of the disparity map or to refine the disparity map.

According to a second example aspect of the present invention, there is provided an apparatus comprising:
at least one memory configured to store calibration information;
two digital image capture units at given offset from one another and with overlapping fields of view so that some image objects may appear in images taken with each of the two image capture units;
a processor configured to cause the apparatus, for forming video image, to sequentially:
cause the two digital image capture units to capture a pair of digital images; store in the at least one memory the captured pair of digital images;
   produce, based the calibration information and the pair of digital images, a disparity map for the pair of digital images;
   form a combined image from the pair of digital images;
   segment the combined image, using the disparity map, to comprise a foreground region and a background region;
   form, from the sequentially formed combined images, synthesized panning images so that for each combined image:
      a perspective shift is applied between the foreground region and background region; and
      a shifting portion of the image is cropped.

The disparity map may be formed for the image objects in the pair of the digital images.

The segmenting of the combined image may be performed by segmenting the combined image into the foreground region and the background region.

The perspective shifting may be applied by shifting at least one of the foreground region and background region.

The apparatus of any of the first and second example aspects may be comprised by or comprise any of a portable device; a handheld device; a digital camera; a camcorder; a game device; a mobile telephone; a game device; a laptop computer; a tablet computer.

According to a third example aspect of the present invention, there is provided an apparatus configured to operate as the apparatus of the first example embodiment and as the apparatus of the second example embodiment such that a one series of synthesized panning images are formed from a one pair of digital images as with the apparatus of the first example aspect and another series of synthesized panning images are formed from a other pairs of digital images as with the apparatus of the second example aspect.

According to a fourth example aspect of the present invention, there is provided a method comprising:
storing calibration information;
taking by two digital image capture units a respective pair of digital images at given offset from one another, with overlapping fields of view so that some image objects may appear in each of the pair of digital images;
storing the pair of digital images;
producing, based the calibration information and the pair of digital images, a disparity map for the pair of digital images;
forming a combined image using the pair of digital images;
segmenting the combined image, using the disparity map, to comprise a foreground region and a background region;
forming a sequence of synthesized panning images so that for each combined image:
   a perspective shift is applied between the foreground region and background region; and
   a shifting portion of the perspective shifted image is cropped.

According to a fifth example aspect of the present invention, there is provided a method comprising:
storing calibration information;
forming video image using two digital image capture units at given offset from one another and with overlapping fields of view so that some image objects may appear in images taken with each of the two image capture units; and
sequentially:
   capturing a pair of digital images using the two digital image capture units;
   storing the captured pair of digital images;
   produce, based the calibration information and the pair of digital images, a disparity map for the pair of digital images;
   forming a combined image from the pair of digital images;
   segmenting the combined image, using the disparity map, to comprise a foreground region and a background region;
   forming, from the sequentially formed combined images, synthesized panning images so that for each combined image:
      a perspective shift is applied between the foreground region and background region; and
      a shifting portion of the image is cropped.

According to a sixth example aspect of the present invention, there is provided an apparatus, comprising a processor configured to:
store calibration information;
take by two digital image capture units a respective pair of digital images at given offset from one another, with overlapping fields of view so that some image objects may appear in each of the pair of digital images;
store the pair of digital images;
produce, based the calibration information and the pair of digital images, a disparity map for the pair of digital images;
form a combined image using the pair of digital images;
segment the combined image, using the disparity map, to comprise a foreground region and a background region;
form a sequence of synthesized panning images so that for each combined image:
   a perspective shift is applied between the foreground region and background region; and
   a shifting portion of the perspective shifted image is cropped.

According to a seventh example aspect of the present invention, there is provided an apparatus, comprising a processor configured to:
store calibration information;
form video image using two digital image capture units at given offset from one another and with overlapping fields of view so that some image objects may appear in images taken with each of the two image capture units; and
sequentially:
   capture a pair of digital images using the two digital image capture units;
   store the captured pair of digital images;
   produce, based the calibration information and the pair of digital images, a disparity map for the pair of digital images;
   form a combined image from the pair of digital images;
   segment the combined image, using the disparity map, to comprise a foreground region and a background region;
   form, from the sequentially formed combined images, synthesized panning images so that for each combined image:
      a perspective shift is applied between the foreground region and background region; and
      a shifting portion of the image is cropped.

According to an eighth example aspect of the present invention, there is provided an apparatus, comprising:
at least one processor; and
at least one memory including computer program code;
the at least one memory and the computer program code configured to, with the at least one processor, cause the apparatus to perform at least the following:
   storing calibration information;
   taking by two digital image capture units a respective pair of digital images at given offset from one another, with overlapping fields of view so that some image objects may appear in each of the pair of digital images;
   storing the pair of digital images;
   producing, based the calibration information and the pair of digital images, a disparity map for the pair of digital images;
   forming a combined image using the pair of digital images;
   segmenting the combined image, using the disparity map, to comprise a foreground region and a background region;
   forming a sequence of synthesized panning images so that for each combined image:
      a perspective shift is applied between the foreground region and background region; and
      a shifting portion of the perspective shifted image is cropped.

According to a ninth example aspect of the present invention, there is provided an apparatus, comprising:
at least one processor; and
at least one memory including computer program code;
the at least one memory and the computer program code configured to, with the at least one processor, cause the apparatus to perform at least the following:
   storing calibration information;
   forming video image using two digital image capture units at given offset from one another and with overlapping fields of view so that some image objects may appear in images taken with each of the two image capture units; and
   sequentially:
      capturing a pair of digital images using the two digital image capture units;
      storing the captured pair of digital images;
      produce, based the calibration information and the pair of digital images, a disparity map for the pair of digital images;
      forming a combined image from the pair of digital images;
      segmenting the combined image, using the disparity map, to comprise a foreground region and a background region;
      forming, from the sequentially formed combined images, synthesized panning images so that for each combined image:
         a perspective shift is applied between the foreground region and background region; and
         a shifting portion of the image is cropped.

According to a tenth example aspect of the present invention, there is provided a computer program, comprising:
code for storing calibration information;
code for taking by two digital image capture units a respective pair of digital images at given offset from one another, with overlapping fields of view so that some image objects may appear in each of the pair of digital images;
code for storing the pair of digital images;
code for producing, based the calibration information and the pair of digital images, a disparity map for the pair of digital images;
code for forming a combined image using the pair of digital images;
code for segmenting the combined image, using the disparity map, to comprise a foreground region and a background region; and
code for forming a sequence of synthesized panning images so that for each combined image:
   a perspective shift is applied between the foreground region and background region; and
   a shifting portion of the perspective shifted image is cropped; when the computer program is run on a processor.

According to an eleventh example aspect of the present invention, there is provided a computer program, comprising:
code for storing calibration information;
code for forming video image using two digital image capture units at given offset from one another and with overlapping fields of view so that some image objects may appear in images taken with each of the two image capture units; and
code for sequentially:
   capturing a pair of digital images using the two digital image capture units;
   storing the captured pair of digital images;
   produce, based the calibration information and the pair of digital images, a disparity map for the pair of digital images;
   forming a combined image from the pair of digital images;
   segmenting the combined image, using the disparity map, to comprise a foreground region and a background region;
   forming, from the sequentially formed combined images, synthesized panning images so that for each combined image:
      a perspective shift is applied between the foreground region and background region; and
      a shifting portion of the image is cropped;
   when the computer program is run on a processor.

The computer program of the tenth or eleventh example aspect may be a computer program product comprising a computer-readable medium bearing computer program code embodied therein for use with a computer.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a schematic system for use as a reference with which some example embodiments of the invention can be explained;

FIG. 2 shows a block diagram of the imaging apparatus of FIG. 1;

FIG. 3 shows a block diagram of an imaging unit according to an example embodiment of the invention;

FIGS. 4a to 4d show fields of view of two digital image capture units with illustrative crop image correspondence;

FIGS. 5a to 5d show similar fields of view of the two digital image capture units when optical image stabilization is utilised;

FIG. 6 shows a flow chart illustrative of a process according to an example embodiment e.g. for capturing still images with synthesized panning effect; and

FIG. 7 shows a flow chart illustrative of a process 700 according to an example embodiment e.g. for capturing video image with synthesized panning effect.

### DETAILED DESCRIPTION OF THE DRAWINGS

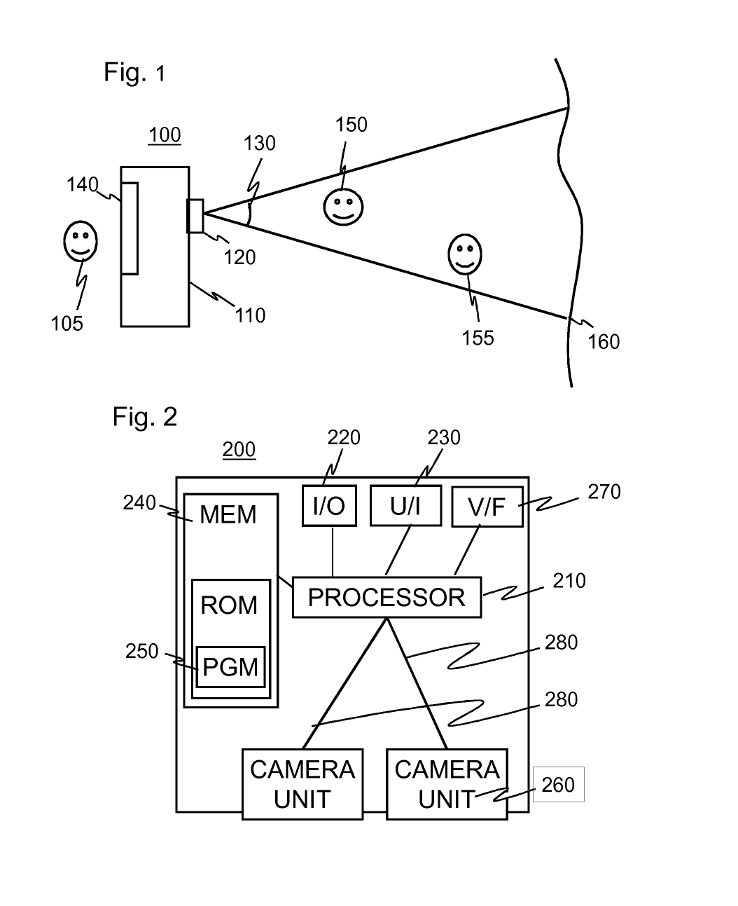

An example embodiment of the present invention and its potential advantages are understood by referring to FIGS. 1 through 7 of the drawings. In this document, like reference signs denote like parts or steps.

The following description first describes various generic structures suitable for implementing some example embodiments after which more specific structures and examples on some processes are described.

FIG. 1 shows a schematic system 100 for use as a reference with which some example embodiments of the invention can be explained. The system 100 comprises a device 110 such as a camera phone, gaming device, security camera device, personal digital assistant, tablet computer or a digital camera having an imaging unit 120 with a field of view 130. The device 110 further comprises a display 140. FIG. 1 also shows a user 105 and an image object 150 that is being imaged by the imaging unit 120 and a background 160 such as a curtain behind the image object.

In FIG. 1, the image object 150 is relatively small in comparison to the field of view at the image object 150. Next to the image object 150, there is a continuous background 160 and a secondary object 155. While this setting is not by any means necessary, it serves to simplify FIG. 1 and description of some example embodiments of the invention.

FIG. 2 shows a block diagram of an imaging apparatus 200 of an example embodiment of the invention. The imaging apparatus 200 is suited for operating as the device 110. The apparatus 200 comprises a communication interface 220, a host processor 210 coupled to the communication interface module 220, and a memory 240 coupled to the host processor 210.

The memory 240 comprises a work memory and a non-volatile memory such as a read-only memory, flash memory, optical or magnetic memory. In the memory 240, typically at least initially in the non-volatile memory, there is stored software 250 operable to be loaded and executed by the host processor 210. The software 250 may comprise one or more software modules and can be in the form of a computer program product that is software stored in a memory medium. The imaging apparatus 200 further comprises a pair of digital image capture units 260 and a viewfinder 270 each coupled to the host processor 210. The viewfinder 270 is implemented in an example embodiment by using a display configured to show a live camera view. The digital image capture unit 260 and the processor 210 are connected via a camera interface 280.

The two digital image capture units 260 are formed in one example embodiment by two digital cameras. In another example embodiment, the two digital image capture units are formed of a common digital camera and of an optical image splitter with two offset and substantially parallel image input ports. Thus, one portion of an image sensor is used to capture one digital image and another portion of the image sensor is used to capture another digital image. The optical image splitter comprises, for example, one or more components selected from a group consisting of mirrors; prisms; afocal optical elements; exit pupil expanders; and focal optical elements. For example, a common image sensor can be arranged in between the two input ports and optically connected thereto.

In an example embodiment, the pair of digital images have substantially overlapping fields of view.

In an example embodiment, the optical axis of the image capture units 260 is parallel or nearly parallel (e.g. up to 1, 2, 3, 4 or 5 degrees difference) when the pair of digital images are taken. In case that the imaging apparatus 200 is equipped with optical image stabilization for at least one of the image capture units, the optical axis of each image capture unit 260 can be determined at the center position provided by the optical image stabilization.

In an example embodiment, the image capture units 260 are identical in terms of any the following functionalities they may have: focal length; image capture angle; automatic exposure control; automatic white balance control; and automatic focus control. In an example embodiment, the image capture units 260 share common control in one or more of these functionalities. In another example embodiment, however, the camera units differ with one or more of these functionalities. Software matching is performed as appropriate according to desired implementation to an image formed in combination of information. Such matching can be directed only on desired crop area.

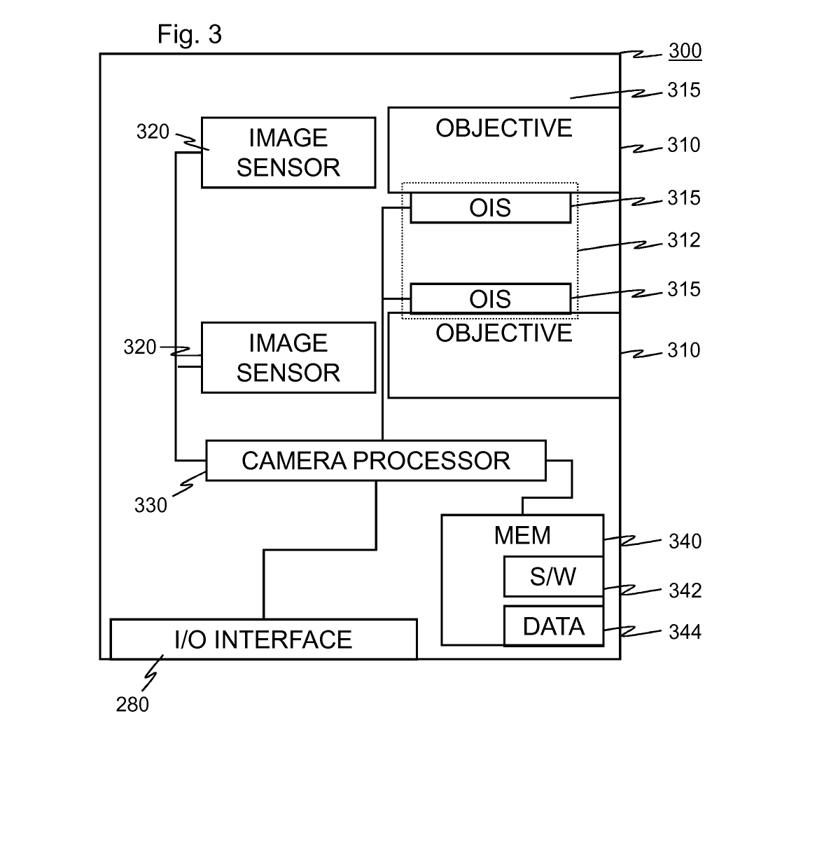

Term host processor refers to a processor in the apparatus 200 in distinction of one or more processors in the digital image capture unit 260, referred to as camera processor(s) 330 in FIG. 3. Depending on implementation, different example embodiments of the invention share processing of image information and control of the imaging unit 300 differently. Also, the processing is performed on the fly in one example embodiment and with off-line processing in another example embodiment. It is also possible that a given amount of images or image information can be processed on the fly and after that off-line operation mode is used as in one example embodiment. The on the fly operation refers e.g. to such real-time or near real-time operation that occurs in pace with taking images and that typically also is completed before next image can be taken.

It shall be understood that any coupling in this document refers to functional or operational coupling; there may be intervening components or circuitries in between coupled elements.

The communication interface module 220 is configured to provide local communications over one or more local links. The links may be wired and/or wireless links. The communication interface 220 may further or alternatively implement telecommunication links suited for establishing links with other users or for data transfer (e.g. using the Internet). Such telecommunication links may be links using any of: wireless local area network links, Bluetooth, ultra-wideband, cellular or satellite communication links. The communication interface 220 may be integrated into the apparatus 200 or into an adapter, card or the like that may be inserted into a suitable slot or port of the apparatus 200. While FIG. 2 shows one communication interface 220, the apparatus may comprise a plurality of communication interfaces 220.

Any processor mentioned in this document is selected, for instance, from a group consisting of at least one of the following: a central processing unit (CPU), a microprocessor, a digital signal processor (DSP), a graphics processing unit, an application specific integrated circuit (ASIC), a field programmable gate array, a microcontroller, and any number of and any a combination thereof. FIG. 2 shows one host processor 210, but the apparatus 200 may comprise a plurality of host processors.

As mentioned in the foregoing, the memory 240 may comprise volatile and a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. In some example embodiments, only volatile or non-volatile memory is present in the apparatus 200. Moreover, in some example embodiments, the apparatus comprises a plurality of memories. In some example embodiments, various elements are integrated. For instance, the memory 240 can be constructed as a part of the apparatus 200 or inserted into a slot, port, or the like. Further still, the memory 240 may serve the sole purpose of storing data, or it may be constructed as a part of an apparatus serving other purposes, such as processing data. Similar options are thinkable also for various other elements.

A skilled person appreciates that in addition to the elements shown in FIG. 2, the apparatus 200 may comprise other elements, such as microphones, displays, as well as additional circuitry such as further input/output (I/O) circuitries, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 200 may comprise a disposable or rechargeable battery (not shown) for powering the apparatus when external power if external power supply is not available.

In an example embodiment, the image capture unit comprises a distance meter such as an ultrasound detector; split-pixel sensor; light phase detection; and/or image analyser for determining distance to one or more image objects visible to the image capture units.

It is also useful to realize that the term apparatus is used in this document with varying scope. In some of the broader claims and examples, the apparatus may refer to only a subset of the features presented in FIG. 2 or even be implemented without any one of the features of FIG. 2. In one example embodiment term apparatus refers to the processor 210, an input of the processor 210 configured to receive information from the digital image capture units 260 and an output of the processor 210 configured to provide information to the viewfinder. For instance, the image processor may comprise the processor 210 and the device in question may comprise the camera processor 330 and the camera interface 280 shown in FIG. 3.

FIG. 3 shows a block diagram of an imaging unit 300 of an example embodiment of the invention. The digital image capture unit 300 comprises two offset positioned objectives 310, respective two optical image stabilizers 315 in an image stabilization unit 312, and two image sensors 320 further respective to the two objectives 310, a camera processor 330, a memory 340 comprising data such as user settings 344 and software 342 with which the camera processor 330 can manage operations of the imaging unit 300. The camera processor 330 operates as an image processing circuitry of an example embodiment. An input/output or camera interface 280 is also provided to enable exchange of information between the imaging unit 300 and the host processor 210. The image sensor 320 is, for instance, a CCD or CMOS unit. In case of a CMOS unit, the image sensor 320 can also contain built-in analog-to-digital implemented on common silicon chip with the image sensor 320. In an alternative example embodiment, a separate A/D conversion is provided between the image sensor 320 and the camera processor 330.

The camera processor 330 takes care in particular example embodiments of one or more of the following functions: digital image stabilization; pixel color interpolation; white balance correction; edge enhancement; aspect ratio control; vignetting correction; combining of subsequent images for high dynamic range imaging; Bayer reconstruction filtering; chromatic aberration correction; dust effect compensation; and downscaling images.

In an example embodiment, the camera processor 330 performs little or no processing at all. The camera processor 330 is entirely omitted in an example embodiment in which the imaging unit 300 merely forms digitized images for subsequent processing e.g. by the host processor 210. For most of the following description, the processing can be performed using the camera processor 330, the host processor 210, their combination or any other processor or processors.

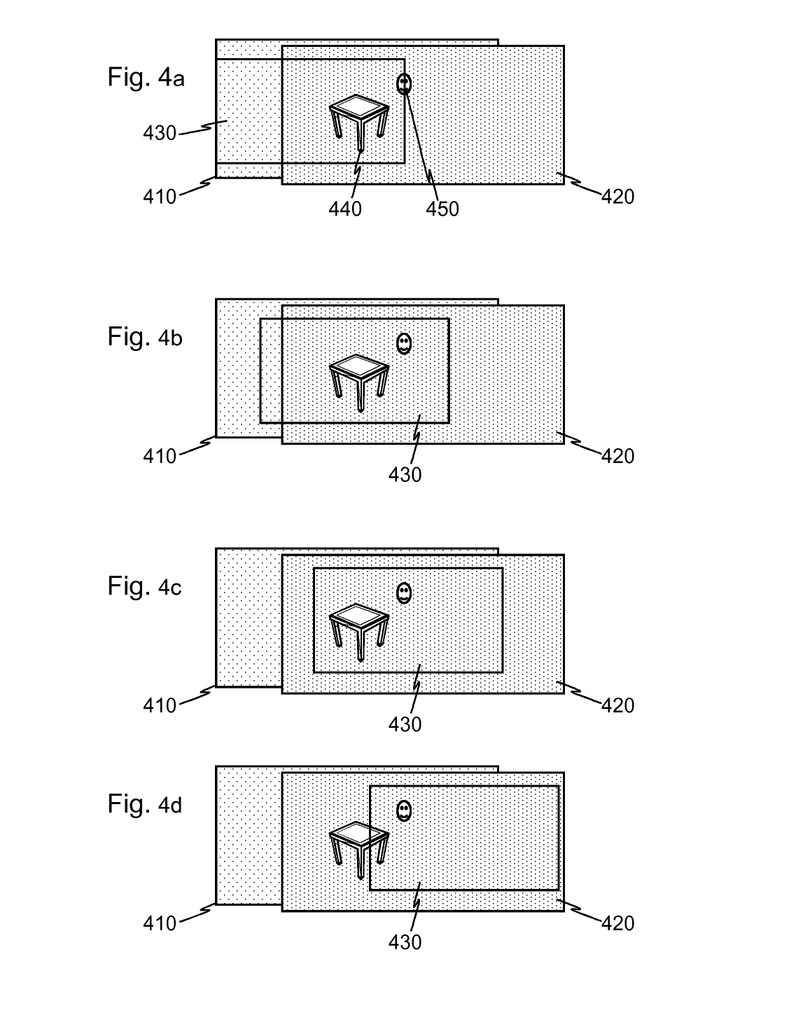

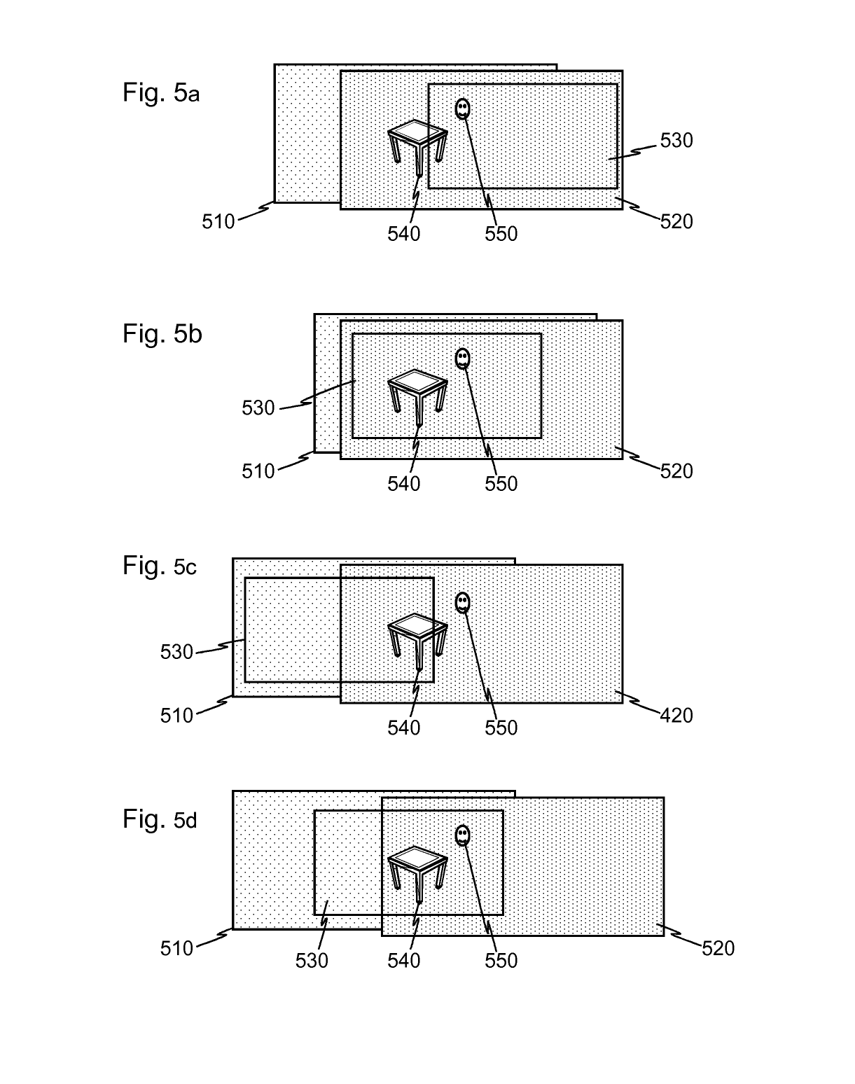

FIGS. 4a to 4d show fields of view 410, 420 of the two digital image capture units 260 with illustrative crop image 430 correspondence. Two image objects 440 and 450 are shown. FIGS. 5a to 5d show similar fields of view 510, 520 of the two digital image capture units 260 with an illustrative crop image 530 correspondence when optical image stabilization is employed to broaden the combined field of view or canvas available for the illustrative crop image.

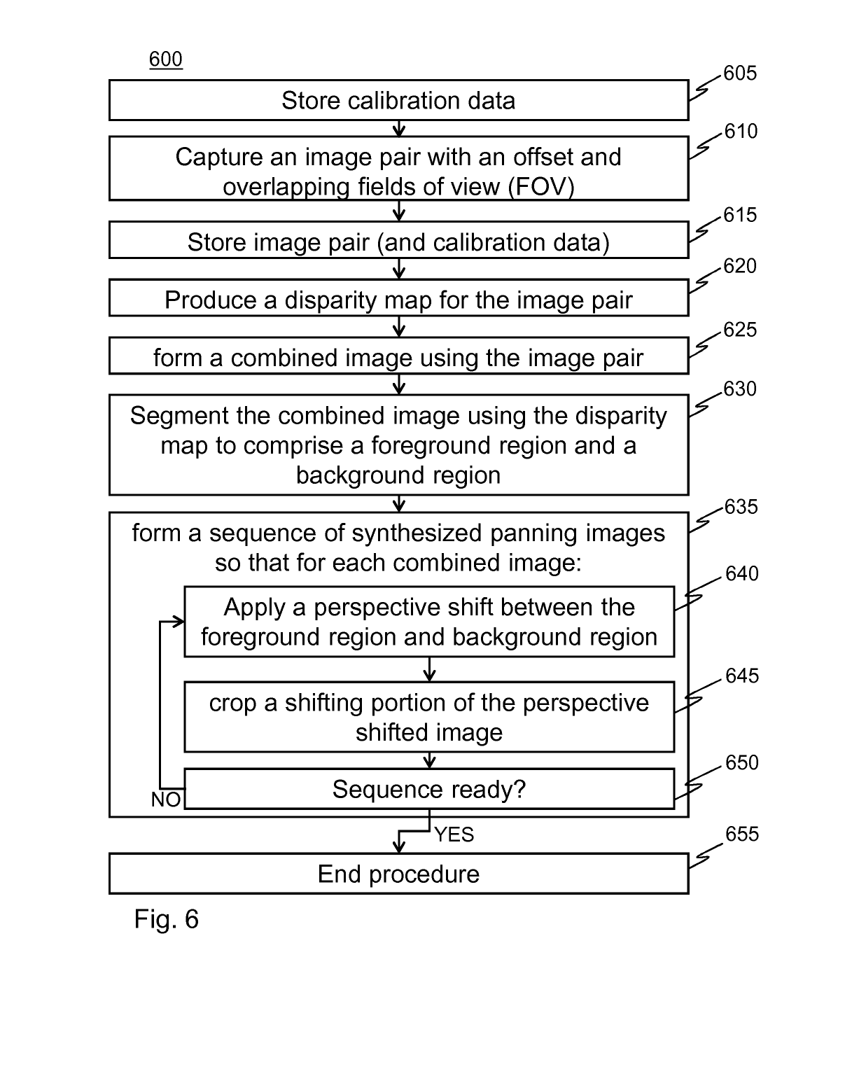

FIG. 5a illustrates a situation in which the fields of view 510, 520 of the two are as in FIG. 4a. FIG. 5b illustrates a situation in which the combined fields of view 510, 520 is narrowed by using the optical image stabilization of one digital image capture unit so that one of the fields of view 510 is more overlapping with the another. Such change can be used to enhance segmenting of a combined image of the two digital image capture units 260, as will be explained with further detail subsequently with reference to FIG. 6.

FIG. 5c illustrates a situation in which the combined fields of view 510, 520 is broadened by using the optical image stabilization of one digital image capture unit so that one of the fields of view 510 is less overlapping with the another.

In FIG. 5d, also to other field of view 520 is shifted to broaden the combined fields of view. FIGS. 5b, 5a, 5c and 5d could be seen as a sequence that demonstrates how the optical image stabilization can be used to broaden the combined field of view or canvas usable for forming a combined image.

In FIGS. 4a to 4d and 5a to 5d, horizontal shifting of the field of view was illustrated. It should be understood that the shifting can be performed along any linear axis (horizontal, vertical, diagonal) and in either direction, possibly shifting also backwards or along a non-linear path depending on the desired implementation.

FIG. 6 shows a flow chart illustrative of a process 600 according to an example embodiment. The process can be performed e.g. using the imaging apparatus 200 that has two digital image capture units 260. Calibration information is stored in at least one memory 605. The calibration information can be stored on manufacture of the imaging apparatus 200 or at a later stage e.g. by a user of the imaging apparatus 200. These image capture units take a respective pair of digital images at given offset from one another, with overlapping fields of view so that some image objects may appear in each of the pair of digital images, 610.

The pair of digital images are stored in at least one memory, 615.

In the process 600, further steps can be performed e.g. by a processor as follows:
produce 620, based on the calibration information and the pair of digital images, a disparity map for the pair of digital images;
form 625, a combined image using the pair of digital images;
segment 630 the combined image, using the disparity map, to comprise a foreground region and a background region;
form 635 a sequence of synthesized panning images so that for each combined image:
   a perspective shift is applied 640 between the foreground region and background region; and
   a shifting portion of the perspective shifted image is cropped 645.

The disparity map is formed in an example embodiment for the image objects in the pair of the digital images.

The segmenting of the combined image is performed in an example embodiment by segmenting the combined image into the foreground region and the background region.

The perspective shifting is applied 640 in an example embodiment by shifting at least one of the foreground region and background region.

The foreground region can be discontinuous in an example embodiment.

The background region can be discontinuous in an example embodiment.

The foreground region refers in an example embodiment to salient object or objects appearing at given distance range from the imaging apparatus 200. In another example embodiment, the foreground region refers to salient objects at differing distance ranges. For example, one or more of the image capture units 260 can be configured to capture images with deep focused range (e.g. using small aperture and/or small focal length) so as to obtain crisp image of objects ranging from near to far. Then, the desired salient objects can be selected e.g. based on an automatic object recognition algorithm such as salient object detection and/or based on user input e.g. with lassoing on a touch display. Excluded parts of the image can be defined as the background region regardless of the distance of objects in the background region from the imaging apparatus 260. In an example embodiment, the background region is then suitably processed to accent the foreground region in a desired manner. The processing in question is selected in an example embodiment from a group consisting of: blurring; reducing total brightness of all colors; reducing brightness of some color channels; reducing color saturation; reducing contrast; and toning e.g. with sepia or black and white processing.

The forming 635 of the sequence of synthesized panning images can be performed e.g. with a loop in which it is checked 650 if the sequence of the synthesized images is ready and if not, then repeating another round through steps 640 and 645, or otherwise ending 655 the procedure.

In an example embodiment, the forming 625 of a combined image from the pair of digital images is performed by mosaicking.

In an example embodiment, the segmenting 630 of the scene is performed with depth based segmentation algorithm(s). The user may be allowed to identify the foreground region to facilitate the segmentation.

For instance, looking at FIGS. 4a to 5d, the stool 540 resides in a foreground region and the face 550 resides in a background region. In this context, the foreground region may refer to an image portion that resides closer to the imaging apparatus 200 than the background region that refers to an image portion farther away from the imaging apparatus 200. Both portions comprise some image objects, although the term image object should also be understood broadly. For instance, one uniform part may appear at different parts of the combined image at different distances and so form both the foreground region and the background region.

Thanks to two digital image capture units, it is possible to see behind the foreground region and to form a 3D view. The forming 625 of the combined image and the segmenting 630 of the combined image can be used to apply 640 the perspective shift such that the foreground region and the background regions can be perspective shifted with relation to each other. This perspective shifting changes the relationship of these regions in a manner that corresponds to the effect of actually panning a camera. In an example embodiment, only the background region is shifted. In another example embodiment, the foreground region is shifted but less than the distance from the imaging apparatus 200 to the objects in the foreground region would cause in real life camera panning. In another example embodiment, the perspective shifting is performed by mimicking effects that would be caused by real life panning such that the shifting of the foreground region and the background region is performed based on their estimated or measured distances from the imaging apparatus.

By cropping a shifting portion of the combined image, the panning effect may be further emphasized. Moreover, the panning effect can be produced from one pair of still images i.e. panning effect can be formed and motion be stopped simultaneously.

As illustrated by images 5a to 5d, the optical image stabilization can be used to control the image capture units to shift affected fields of view from one image to another in the direction of the synthesized panning.

In an example embodiment, a preview on the display is presented to illustrate synthesized panning that can be produced with current view of the image capture units.

In an example embodiment, user determination of at least one parameter is input for use in any one or more of the producing of the disparity map; forming of the combined image; segmenting of the combined image; and forming of the sequence of synthesized panning images. For example, the user input can be obtained with a touch screen by recognizing a gesture such as swiping on the touch screen.

In an example embodiment, the optical image stabilization is used to perform both image stabilization and the shifting of the view for producing the synthesized panning effect. In this case, the optical image stabilization can be performed to the extent possible after the shifting of the view.

In an example embodiment that can be illustrated by FIGS. 5a to 5d, the digital image capture units are controlled to take a plurality of the pairs of the digital images and the optical image stabilization unit are used to perform the shifting of the view differently for different pairs of digital images. The disparity map can be produced based on the plurality of pairs of digital images. The forming of the combined image can then be performed using the plurality of pairs of digital images. Changing mutual geometry of the image capture units can be used to facilitate the producing of the disparity map or to refine the disparity map.

In an example embodiment, an animation file is formed of the sequence of the synthesized panning images.

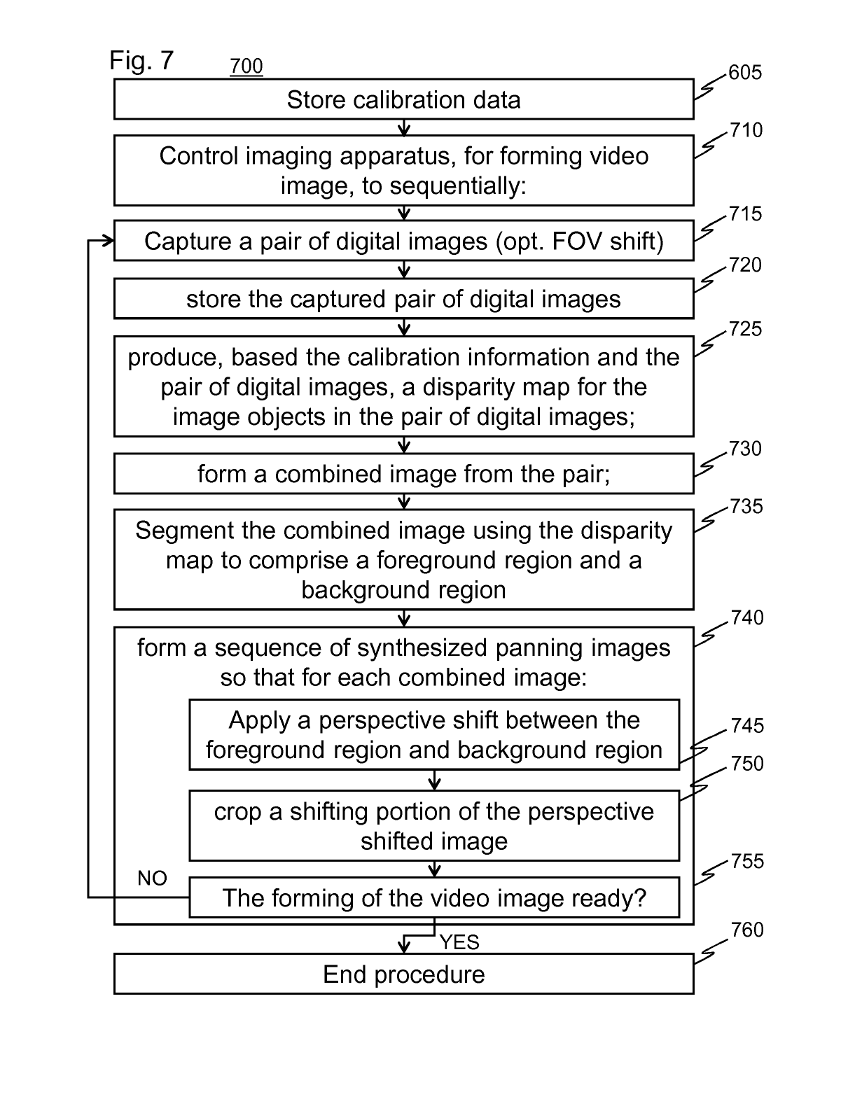

FIG. 7 shows a flow chart illustrative of a process 700 according to an example embodiment. This process 700 can be performed e.g. using the imaging apparatus 200 that has two digital image capture units 260. As explained in the foregoing, the two digital image capture units 260 are at given offset from one another and with overlapping fields of view so that some image objects may appear in images taken with each of the two image capture units.

Calibration information is stored, 605.

The imaging apparatus is controlled 710, for forming video image, to sequentially:
cause the two digital image capture units to capture a pair of digital images, 715;
store 720 the captured pair of digital images;
   produce 725, based the calibration information and the pair of digital images, a disparity map for the pair of digital images;
   form 730 a combined image from the pair of digital images;
   segment 735 the combined image, using the disparity map, to comprise a foreground region and a background region;
   form, 740 from the sequentially formed combined images, synthesized panning images so that for each combined image:
      a perspective shift is applied between the foreground region and background region 745; and
      a shifting portion of the image is cropped 750.

In an example embodiment, the operation repeatedly resumes in step 755 to step 715 until desired number of pairs of digital images are captured (when the forming of the video image is not ready). When the video image forming is ready, the process advances from step 755 to end of procedure, 760.

In another example embodiment, a plurality of pairs of digital images is first captured before further processing such as the producing 725 of the disparity map, the forming 730 of the combined image, the segmenting 735 and the forming of the sequence 740.

In an example embodiment, optical image stabilization is used on returning to the capture of a new pair of digital images for shifting the field of view of at least one of the image capture units 260. In this case, the capture a pair of digital images, 715, can be understood as comprising optional shifting of the field of view.

Unlike with the process 600 illustrated by FIG. 6, the process 700 illustrated by FIG. 7 forms video image by capturing sequentially pairs of digital images. While a panning effect is formed largely corresponding to the process 6 of FIG. 6, the operation is not based on a single pair of digital images. Hence, motion is not so stopped as with the process 600 of FIG. 6, while it is still possible to form the panning effect e.g. even if the imaging apparatus 200 were fixed or not moved. This process of FIG. 7 could be used e.g. in surveillance camera systems to enable seeing better behind obstructing people and objects.

Without in any way limiting the scope, interpretation, or application of the claims appearing below, a technical effect of one or more of the example embodiments disclosed herein is that a synthesized panning effect can be formed from a pair of digital images to enhance the user experience of digital imaging. Another technical effect of one or more of the example embodiments disclosed herein is that the synthesized panning effect can be previewed and adapted by a user of a digital imaging apparatus before capturing the image or video image. Another technical effect of one or more of the example embodiments disclosed herein is that more information can be presented to a viewer by the synthesized panning effect as some otherwise obstructed image portions become visible through the synthesized panning.

Embodiments of the present invention may be implemented in software, hardware, application logic or a combination of software, hardware and application logic. The software, application logic and/or hardware may reside on fixed, removable or remotely accessible memory medium. If desired, part of the software, application logic and/or hardware may reside on an imaging apparatus, part of the software, application logic and/or hardware may reside on a host device that contains the imaging apparatus, and part of the software, application logic and/or hardware may reside on a processor, chipset or application specific integrated circuit. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims. The appended abstract is incorporated by reference herein as one example embodiment.

It is also noted herein that while the foregoing describes example embodiments of the invention, these descriptions should not be viewed in a limiting sense. Rather, there are several variations and modifications which may be made without departing from the scope of the present invention as defined in the appended claims.

1. An apparatus comprising:
at least one memory configured to store calibration information;
two digital image capture units configured to take a respective pair of digital images at given offset from one another, with overlapping fields of view so that some image objects may appear in each of the pair of digital images;
the at least one memory being further configured to store the pair of digital images; a processor configured to:
produce, based the calibration information and the pair of digital images, a disparity map for the pair of digital images;
form a combined image using the pair of digital images;
segment the combined image, using the disparity map, to comprise a foreground region and a background region;
form a sequence of synthesized panning images so that for each combined image:
a perspective shift is applied between at least one of the the foreground region and background region; and
a shifting portion of the perspective shifted image is cropped.

2.-5. (canceled)

6. The apparatus of claim 1, wherein the two digital image capture units are formed of a common digital camera and of an optical image splitter with two offset and substantially parallel image input ports.

7. The apparatus of claim 1, wherein the pair of digital images have substantially overlapping fields of view.

8.-9. (canceled)

10. The apparatus of claim 1, wherein the processor is configured to enable a user of the apparatus to identify the foreground region to facilitate the segmentation.

11. The apparatus of claim 10, wherein the processor is further configured to form an animation file of the sequence of the synthesized panning images.

12. The apparatus of claim 1, further comprising an optical image stabilization unit configured to optically stabilize at least one of the digital images of the pair of digital images.

13. The apparatus of claim 12, wherein the processor is further configured to control the optical image stabilization unit and to control the image capture units so as to take multiple images shifting the view affected by optical image stabilization unit from one image to another in the direction of the synthesized panning.

14. The apparatus of claim 12, wherein processor is configured to control the optical image stabilization unit to perform both image stabilization and the shifting of the view.

15. The apparatus of claim 14, wherein the processor is configured to cause the optical image stabilization to be performed to the extent possible after the shifting of the view.

16. The apparatus of claim 12, wherein the processor is further configured to cause the digital image capture units to take a plurality of the pairs of the digital images and to cause the optical image stabilization unit to perform the shifting of the view differently for different pairs of digital images.

17. (canceled)

18. The apparatus of claim 16, wherein the processor is further configured to perform the forming of the combined image using the plurality of pairs of digital images.

19. The apparatus of claim 12, wherein the processor is further configured to use the changing mutual geometry of the image capture units to facilitate the producing of the disparity map or to refine the disparity map.

20. The apparatus of claim 1, further comprising a display.

21. The apparatus of claim 20, wherein the processor is configured to cause presenting a preview on the display to illustrate synthesized panning that can be produced with current view of the image capture units.

22. The apparatus of claim 20, further comprising a user input.

23. The apparatus of claim 22, wherein the processor is further configured to enable user determination of at least one parameter and to use the at least one parameter in any one or more of: the producing of the disparity map; the forming of the combined image; the segmenting of the combined image; and the forming of the sequence of synthesized panning images.

24. The apparatus of claim 22, wherein the user input comprises a touch screen.

25. The apparatus of claim 24, wherein the processor is configured to at least partly form the at least one parameter by recognizing a gesture such as swiping on the touch screen.

26. An apparatus comprising:
at least one memory configured to store calibration information;
two digital image capture units at given offset from one another and with overlapping fields of view so that some image objects may appear in images taken with each of the two image capture units;
a processor configured to cause the apparatus, for forming video image, to sequentially:
cause the two digital image capture units to capture a pair of digital images;
store in the at least one memory the captured pair of digital images;
produce, based the calibration information and the pair of digital images, a disparity map for the pair of digital images;
form a combined image from the pair of digital images;
segment the combined image, using the disparity map, to comprise a foreground region and a background region;
form, from the sequentially formed combined images, synthesized panning images so that for each combined image:
a perspective shift is applied between the foreground region and background region; and
a shifting portion of the image is cropped.

27.-30. (canceled)

31. A method comprising:
storing calibration information;
taking by two digital image capture units a respective pair of digital images at given offset from one another, with overlapping fields of view so that some image objects may appear in each of the pair of digital images;
storing the pair of digital images;
producing, based the calibration information and the pair of digital images, a disparity map for the pair of digital images;
forming a combined image using the pair of digital images; segmenting the combined image, using the disparity map, to comprise a foreground region and a background region;
forming a sequence of synthesized panning images so that for each combined image:
a perspective shift is applied between the foreground region and background region; and
a shifting portion of the perspective shifted image is cropped.

32.-34. (canceled)

35. The method of claim 31, wherein the pair of digital images have substantially overlapping fields of view.

36.-37. (canceled)

38. The method of claim 31, further comprising enabling a user to identify the foreground region to facilitate the segmentation.

39. The method of claim 31, further comprising forming an animation file of the sequence of the synthesized panning images.

40. The method of claim 31, further comprising optically stabilizing at least one of the digital images of the pair of digital images.

41. The method of claim 31, further comprising controlling the optical image stabilizing unit and the image capture units to take multiple images shifting the view affected by optical image stabilizing from one image to another in the direction of the synthesized panning.

42. The method of claim 40, comprising performing both image stabilizing and the shifting of the view.

43. The method of claim 42, comprising performing the optical image stabilizing to the extent possible after the shifting of the view.

44. The method of claim 40, further comprising taking a plurality of the pairs of the digital images and performing the optical image stabilizing to perform the shifting of the view differently for different pairs of digital images.

45. (canceled)

46. The method of claim 44, further comprising performing the forming of the combined image using the plurality of pairs of digital images.

47. The method of claim 40, further comprising using the changing mutual geometry of the image capture units to facilitate the producing of the disparity map or to refine the disparity map.

48. The method of claim 31, further comprising displaying a preview to illustrate synthesized panning that can be produced with current view of the image capture units.

49. The method of claim 31, further comprising receiving a user determination of at least one parameter and using the at least one parameter in any one or more of: the producing of the disparity map; the forming of the combined image; the segmenting of the combined image; and the forming of the sequence of synthesized panning images.

50. The method of claim 49, wherein the at least one parameter determined at least partly by recognizing a gesture of a user on a touch screen.

51.-57. (canceled)

58. A computer program, comprising:
code for storing calibration information;
code for taking by two digital image capture units a respective pair of digital images at given offset from one another, with overlapping fields of view so that some image objects may appear in each of the pair of digital images;
code for storing the pair of digital images;
code for producing, based the calibration information and the pair of digital images, a disparity map for the pair of digital images;
code for forming a combined image using the pair of digital images;
code for segmenting the combined image, using the disparity map, to comprise a foreground region and a background region; and
code for forming a sequence of synthesized panning images so that for each combined image:
a perspective shift is applied between the foreground region and background region; and
a shifting portion of the perspective shifted image is cropped;
when the computer program is run on a processor.

59. (canceled)
